(19) United States
(12) Patent Application Publication
(10) Pub. No.: US 2019/0184749 A1
(43) Pub. Date: Jun. 20, 2019

(54) PNEUMATIC TIRE

(71) Applicant: Toyo Tire & Rubber Co., Ltd., Itami-shi (JP)

(72) Inventor: Kazuhide Adachi, Itami-shi (JP)

(73) Assignee: Toyo Tire & Rubber Co., Ltd., Itami-shi (JP)

(21) Appl. No.: 16/204,704

(22) Filed: Nov. 29, 2018

(30) Foreign Application Priority Data
Dec. 15, 2017 (JP) 2017-240998
Dec. 15, 2017 (JP) 2017-241004

(51) Int. Cl. B60C 9/00; D07B 1/02

(52) U.S. Cl. CPC B60C 9/0042; D07B 1/025; B60C 2009/0092; D07B 2501/2046; D07B 2201/104; D07B 2205/205; B60C 2009/0085

(57) ABSTRACT

A pneumatic tire is disclosed that can improve high-speed durability and shock resistance without increasing the mass of a belt reinforcing layer. The pneumatic tire includes a carcass, a belt on the outer periphery of a crown part of the carcass and a belt reinforcing layer on the outer periphery of the belt, wherein the belt reinforcing layer is provided with a belt reinforcing ply including an organic fiber cord having a double twisting structure obtained by intertwisting two first twisted yarns including a filament bundle of aliphatic polyamide fibers, having nominal fineness of 4000 dtex or less and having tensile toughness (J) per one cord of 5 J or more, and a major diameter direction of the belt reinforcing ply is parallel to a belt outer periphery, and the product of the toughness (J) per one organic fiber cord and cord count (number/25 mm) is 130 to 180.

### BACKGROUND

### 1. Field of the Invention

The present invention relates to a pneumatic tire.

### 2. Related Art

When an organic fiber cord such as nylon 66 is used in a belt reinforcing layer of a pneumatic tire, a method for improving shock resistance includes a method of increasing cord count and a method of increasing a cord diameter. However, when those methods are used, there was the problem that the use thereof leads to the decrease of high-speed durability and the increase of tire mass due to the increase of mass of members.

For this problem, JP-A-2008-265688 has an object to provide a pneumatic radial tire that can achieve both high-speed durability and load durability and discloses a pneumatic radial tire comprising at least one belt layer 6 arranged on the outer peripheral side of a carcass layer 4 in a tread part 1 and a belt reinforcing layer 7 comprising a reinforcing cord wound in a tire circumferential direction on the outer peripheral side of the belt layer 6, wherein a hybrid cord formed by intertwining a rayon first yarn with a lyoccell first twist layer and having a twist coefficient α of second twist in a range of 1,400≤α≤3,800, breaking extension of 10% or more and a. toughness coefficient β of 1,260 or more is used as the reinforcing cord of the belt reinforcing layer 7.

JP-A-2017-19461 discloses a pneumatic tire comprising a belt layer 7 having cords obliquely arranged in the tire circumferential direction on the outer peripheral side of a carcass layer 4 in a tread part 3, and a belt reinforcing layer 9 having organic fiber cords arranged along the tire circumferential direction on the outer peripheral side of the belt layer, wherein a cord comprising an aliphatic polyamide fiber and having the product of a load (cN/dtex) at 2% extension and loss tangent tan δ at temperature of 100° C. of 0.035 to 0.044 is used as the organic fiber cord of the belt reinforcing layer. This patent document has an object to provide a pneumatic tire that can reduce rolling resistance while improving flat spot resistance, and does not contain the description relating to high-speed durability and shock resistance.

However, the conventional tires were still required to further improve high-speed durability and shock resistance.

### SUMMARY

In view of the above, the present invention has an object to provide a pneumatic tire that can improve high-speed durability and shock resistance without increasing the mass of a belt reinforcing layer.

The pneumatic tire according to the present invention comprises a carcass, a belt arranged on the outer periphery of a crown part of the carcass and a belt reinforcing layer arranged on the outer periphery of the belt, wherein the belt reinforcing layer is provided with a belt reinforcing ply which comprises an organic fiber cord having a double twisting structure obtained by intertwisting two first twisted yarns comprising a filament bundle of aliphatic polyamide fibers, having nominal fineness of 4000 dtex or less and having tensile toughness (J) per one cord of 5 J or more, and said belt reinforcing ply is arranged such that its major diameter direction is parallel to a belt outer periphery, and the product of the toughness (J) per one organic fiber cord and cord count (number/25 mm) is 130 to 180.

The belt reinforcing layer preferably has the product of a load (N) at 2% extension and the cord count (number/25 mm) of 470 or more.

The aliphatic polyamide fiber preferably comprises nylon 66.

The belt reinforcing layer preferably has the cord occupancy per unit width in the belt reinforcing ply of 85% or less.

According to the pneumatic tire of the present invention, excellent high-speed durability and shock resistance are obtained without increasing the mass of the belt reinforcing layer. Furthermore, according to the pneumatic, tire of more preferred embodiment, excellent driving stability is obtained in addition to the above effect.

### BRIEF DESCRIPTION OF THE DRAWING

FIG. 1 is a semi-cross-sectional view of a pneumatic tire according to one embodiment of the present invention.

### DETAILED DESCRIPTION

Elements in the embodiments for carrying out the present invention are described in detail below.

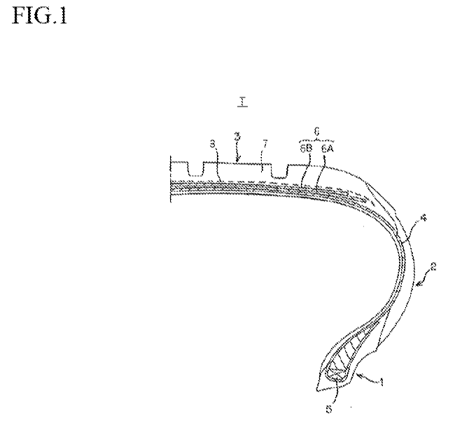

A pneumatic tire T of the embodiment shown in FIG. 1 is a pneumatic radial tire and comprises a pair of right and left bead parts 1 and sidewall parts 2, and a tread part 3 provided between both sidewall parts so as to link radially outer edges of the right and left sidewall parts 2 each other, and a carcass 4 extending across a pair of the bead parts is provided.

The carcass 4 comprises at least one carcass ply having both edges through the sidewall part 2 from the tread part 3 and locked by a ring-shaped core 5 embedded in the head part 1. The carcass ply comprises a carcass cord comprising an organic fiber cord or the like, substantially arranged at a right angle to the tire circumferential direction.

A belt 6 is provided between the carcass 4 and a tread rubber part 7 at an outer peripheral side (that is, tire radially outer side) of the carcass 4 in the treat part 3. The belt 6 is provided by piling on the outer periphery of the crown part of the carcass and can be constituted of one belt ply or a plurality of belt plies, generally at least two belt plies. In the present embodiment, the belt is constituted of two belt plies of a first belt ply 6A at a carcass side and a second belt ply 6B at a tread rubber part side. The belt plies 6A and 6B comprise steel cords inclined at a predetermined angle (for example, 15 to 35°) to a tire circumferential direction and arranged in a tire width direction at predetermined intervals. Each belt ply comprises steel cords covered with a coating rubber. The steel cords are disposed so as to mutually cross between the two belt plies 6A and 6B.

A belt reinforcing layer 8 is provided between the belt 6 and the tread rubber part 7 at an outer peripheral side (that is, tire radially outer side) of the belt 6. The belt reinforcing layer 8 is a cap ply covering the entire width of the belt 6 with a belt reinforcement ply, and comprises organic fiber cords in which its major diameter is arranged substantially in parallel to a tire outer circumferential direction. In other words, the belt reinforcing layer 8 comprises the organic fiber cords arranged along the tire circumferential direction and can be formed by spirally winding the organic fiber cords at an angle of 0 to 5° to the tire circumferential direction so as to cover the entire width direction of the belt 6.

The belt reinforcing layer 8 of the present embodiment comprise an organic fiber cord having a double twisting structure obtained by intertwisting two first twisted yarns comprising a filament bundle of aliphatic polyamide fiber, and having a nominal fineness of 4000 dtex or less and tensile toughness (J) per one cord of 5 J or more. The “tensile toughness (J)” used herein means an amount of work (fracture energy) to be done until a tensile test is conducted using a tensile tester after allowing to stand under constant temperature conditions of 20° C. and 65% RH for 24 hours according to JIS L1017 and fibers are destroyed due to extension from a stress-strain curve (hereinafter S-S curve) obtained. The tensile toughness can be adjusted by nominal fineness of the organic fiber cord, and the like.

The resin used as the aliphatic polyamide fiber is not particularly limited, and examples thereof include aliphatic polyamide resins such as nylon 6, nylon 66nylon 46, nylon 11, nylon 12, nylon 610, nylon 612, nylon 6/66 copolymer, nylon 6/66/610 copolymer, nylon MXD6, nylon 6T and nylon 6/6T copolymer. Of those, nylon 66 is preferred.

The organic fiber cord is obtained by first twisting a filament bundle of the aliphatic polyamide fibers and second twisting at least two yarns obtained by first twisting. For example, the organic fiber cord can be prepared by arranging in parallel two first twisted yarns each obtained by intertwisting a filament bundle of aliphatic polyamide fibers in Z direction and intertwisting those in S direction reverse to the twisting direction of first twisting. The number of first twist and second twist is not particularly limited, but is preferably 20 to 40 times/10 cm. Furthermore, the number of first twist and the number of second twist are preferably set to about the same degree of the value.

The cord thus intertwisted is generally subjected to a dip treatment using the conventional adhesive treatment liquid, thereby the organic cord as a dip-treated cord is obtained.

The nominal fineness of the organic fiber cord is not particularly limited so long as it is 4000 dtex or less, but is preferably 2000 to 3500 dtex and more preferably 2000 to 3000 dtex. When the nominal fineness is 4000 dtex or less, the mass of a tire is easy to be suppressed from increasing. The nominal fineness of the organic fiber cord is the total value of the fineness of two yams to be intertwisted.

The tensile toughness (J) per one organic fiber cord is not particularly limited so long as it is 5 J or more, but is preferably 5 to 10 J. When the tensile toughness (J) is 5 J or more, excellent shock resistance is easy to be obtained.

A method for forming the belt reinforcing layer 8 on the belt 6 using the organic fiber cord is not particularly limited. For example, a plurality of organic fiber cords are arranged in parallel and covered with a rubber and the resulting composite may be spirally wound on the belt of a green tire. Alternatively, a wide rubber-coated sheet comprising organic fiber cords arranged in parallel may be wound by one round on the belt 6. Thus, a pneumatic tire is obtained by producing a green tire in the state that the belt reinforcing layer 8 has been wound on the outer periphery of the belt 6 and vulcanization molding the green tire obtained.

The product of the tensile toughness (J) per one organic fiber cord and the cord count (number/25 mm) is 130 to 180 and preferably 140 to 170. When the product of the tensile toughness (J) per one organic fiber cord and the cord count (number/25 mm) is 130 or more, excellent shock resistance is easy to be obtained. On the other hand, when the product of the tensile toughness (J) per one organic fiber cord and the cord count (number/25 mm) is 180 or less, the cord count does not excessively increase and excellent high-speed durability is easy to be maintained.

The product of the load (N) at 2% extension per one organic fiber cord and the cord count (number/25 mm) is not particularly limited, but is preferably 470 or more and more preferably 470 to 550. When the product of the load (N) at 2% extension per one organic fiber cord and the cord count (number/25 mm) is 470 or more, excellent driving stability is easy to be obtained.

The “load (N) at 2% extension” per one organic fiber cord used herein means tensile load (N) when elongated 2% by allowing to stand under the constant temperature conditions of 20° C. and 65% RH for 24 hours and conducting a tensile test using a tensile tester according to JIS L1017.

The load (N) at 2% extension per one organic fiber cord is not particularly limited, but is preferably 10 to 20N and more preferably 13 to 18N. The load (N) at 2% extension can be adjusted by twisting number of first twist or second twist.

The cord occupancy per unit width in the belt reinforcing ply is not particularly limited, but is preferably 85% or less and more preferably 55 to 85%. When the cord occupancy is 85% or less, excellent high-speed durability is easy to be maintained.

The kind of the pneumatic tire according to the present invention is not particularly limited, and examples of the pneumatic tire include various tires such tires for passenger cars and tires for heavy load used in trucks or buses.

The tire in which the belt reinforcing layer 8 is a cap ply covering the entire width of the belt 6 is described in the above embodiment. However, the present invention is not limited to this embodiment, and the belt reinforcing layer may be an edge ply covering a tire width direction outer edge of the belt 6 and its periphery, and the edge ply may be an edge ply comprising a portion in which both edges in tire width direction of the cap ply have been folded back.

### EXAMPLES

Examples of the present invention are described below, but the invention is not construed to be limited to those Examples.

### Example A

Organic fiber cords having structures shown in Table 1 below were prepared. Measurement methods of those organic fibers cords are as follows.

Cord diameter (mm): Four organic fiber cords obtained were arranged in parallel so as not to be loose and measured with a dial gauge (leg diameter: 9.5 mm).

Tensile toughness (J): According to JIS L1017 after allowing to stand under constant temperature conditions of 20° C. and 65% RH for 24 hours, a tensile test is conducted using a tensile tester and an amount of work (fracture energy) to be done until fibers are destroyed due to extension was obtained from the S-S curve obtained.

The organic fiber cord obtained was used as a cord for a belt reinforcing layer, and a radial tire having a tire size of 225/60 R17 was vulcanization molded according to the conventional method. Each tire obtained had the common constitution except for the constitution of the belt reinforcing layer. Steel cord in the belt ply had 2+1×0.27 structure, and the cord count was 19 numbers/inch. An angle of the steel cord in the belt ply (6A)/(6B) was +25°/−25° to the tire circumferential direction. The belt reinforcing ply was prepared by arranging cords with the cord count shown in Table 1 such that each major diameter direction is in parallel to the belt surface and forming a topping sheet using a calender.

The carcass ply was two plies of polyethylene terephthalate cord of 1100 dtex/2 and cord count 22 numbers/25 mm.

Regarding the topping sheet, the thickness of the belt reinforcing ply was obtained. The measurement method is as follows.

Thickness of belt reinforcing ply: The thickness is a thickness as a belt reinforcing ply comprising organic fiber cord covered with a coating rubber, and measured by a dial gauge (diameter of leg: 9.5 mm).

In each pneumatic tire obtained, mass, shock resistance and high-speed durability of the belt reinforcing layer were evaluated. Evaluation method of each evaluation item is described below. In Comparative Examples 2 and 3, the mass of the belt reinforcing layer increased and in Comparative Example 3, shock resistance was poor as compared with the Conventional Example. Therefore, high-speed durability was not evaluated in those Comparative Examples.

Mass of belt reinforcing layer: The mass is total mass of belt reinforcing plies used per one tire and was indicated by an index as the total mass of the belt reinforcing plies of the Conventional Example being 100. The mass is small as the value is small.

Shock resistance: Topping sheet comprising organic cord topped with a rubber was vulcanized, and a rubber composite obtained was used as a sample. A metal rod (tip shape: semi-sphere, diameter: 1 cm) was pushed to the sample in a rate of 5 mm/min using a tensile tester (Autograph manufactured by Shimadzu Corporation) until the organic fiber cord broken or the metal rod penetrated through the sample. The test was completed when the above state was obtained, and the total amount of energy up to the maximum point was measured. The shock resistance was indicated by an index as the shock resistance of the Conventional Example being 100. The shock resistance is excellent as the index is large.

High speed durability: According to FMVSS 109 (UTGQ), the high-speed durability was measured as follows by a drum tester having a rotating drum made of iron and having smooth surface and a diameter of 1,700 mm. Test tire having an internal pressure of 220 kPa (2.2 kgf/cm²) was mounted on a standard rim specified JIS, and the load was 88% of the maximum load specified in JATMA. Running-in was conducted at a speed of 80 km/hr, the test tire was naturally cooled and air pressure was again adjusted. Thereafter, running was conducted. The running was started from 120 km/hr, the speed was then increased 8 km/hr every 30 minutes passed and the running was conducted until the occurrence of failure. The total running distance of the running was indicated by an index as Conventional Example being 100. High speed durability is excellent as the index is large.

The results obtained are shown in Table 1 below.

TABLE 1

| | | Conven- | | | Compar- | Compar- | Compar- | Compar- |
|---|---|---|---|---|---|---|---|---|
| | | tional | | | ative | ative | ative | ative |
| | | Example 1 | Example 1 | Example 2 | Example 1 | Example 2 | Example 3 | Example 4 |
| Constitution | Material of cord | Ny66 | Ny66 | Ny66 | Ny66 | Ny66 | Ny66 | Ny66 |
| of belt | Constitution | 1400 dtex/2 | 1400 dtex/2 | 1400 dtex/2 | 1400 dtex/2 | 1400 dtex/2 | 1400 dtex/2 | 1400 dtex/2 |
| reinforcing | Nominal fineness (dtex) | 2800 | 2800 | 2800 | 2800 | 4200 | 2800 | 2800 |
| layer | Number of twist per 10 cm length | 37.8/38.6 | 26.2/27.6 | 26.2/27.6 | 37.8/38.6 | 31.3/30.5 | 26.2/27.6 | 26.2/27.6 |
| | (second/first) | | | | | | | |
| | Cord diameter (mm) | 0.68 | 0.67 | 0.67 | 0.68 | 0.84 | 0.68 | 0.67 |
| | Cord count (number/25 mm) | 30.0 | 30.0 | 28.0 | 34.0 | 25.0 | 23.0 | 34.0 |
| | Tensile toughness (J) | 4.3 | 5.4 | 5.4 | 4.3 | 6.9 | 5.4 | 5.4 |
| | Tensile toughness (J) × cord count | 129 | 162 | 151 | 146 | 173 | 124 | 184 |
| | (number/25 mm) | | | | | | | |
| | Thickness of belt reinforcing Ply | 1.0 | 10 | 1.0 | 1.0 | 1.1 | 1.0 | 1.0 |
| | (mm) | | | | | | | |
| Evaluation | Mass of belt reinforcing layer | 100 | 99 | 100 | 99 | 105 | 102 | 98 |
| | Shock resistance | 100 | 110 | 107 | 105 | 114 | 98 | 117 |
| | High speed durability | 100 | 102 | 103 | 95 | — | — | 96 |

The followings are seen from the results shown in the above Table.

In Examples 1 and 2, shock resistance and high-speed durability were excellent while maintaining lightness of the belt reinforcing ply, as compared with Conventional Example 1.

Comparative Example 1 is the example in which tensile toughness (J) per one organic fiber cord is outside the predetermined range, and high-speed durability was poor as compared with Conventional Example 1.

Comparative Example 2 is the example in which the nominal fineness of the organic fiber cord is outside the predetermined range, and the mass of the belt reinforcing ply increased as compared with Conventional Example 1.

Comparative Example 3 is the example in which the product of the tensile toughness (J) per one organic fiber cord and the cord count (number/25 mm) is outside the predetermined range. The mass of the belt reinforcing ply increased and shock resistance was poor, as compared with Conventional Example 1.

Comparative Example 4 is the example in which the product of the tensile toughness (J) per one organic fiber cord and the cord count (number/25 mm) is outside the predetermined range, and high-speed durability was poor as compared with Conventional Example 1.

### Example B

Organic fiber cords having structures shown in Table 2 below were prepared. The measurements of the cord diameter and tensile toughness of the organic fiber cords are the same as described before. The measurement method of the load at 2% extension is as follows.

Load (N) at 2% extension: According to JIS L1017, after allowing to stand under constant temperature conditions of 20° C. and 65% RH for 24 hours, a tensile test is conducted using a tensile tester, and tensile load (N) at 2% extension was measured.

Similar to Example A, belt reinforcing ply (topping sheet) was prepared using the organic fiber cord obtained as the cord for a belt reinforcing layer, and a radial tire having a tire size of 225/60 R17 was manufactured using each belt reinforcing ply. The thickness of the belt reinforcing ply and the cord occupancy in each topping sheet obtained were obtained. The measurement of the thickness of the belt reinforcing ply is the same as described before, and the measurement method of the cord occupancy is as follows.

Cord occupancy (%)=(Cord diameter (mm)×cord count(number/25 mm))×100/25 (mm)

The mass of the belt reinforcing layer, shock resistance, driving stability and high-speed durability of each pneumatic tire obtained were evaluated. The evaluation methods of the mass of the belt reinforcing layer, shock resistance, driving stability and high-speed durability are the same as described before, and the evaluation method of the driving stability is as follows. The mass of the belt reinforcing ply increased in Comparative Examples 6 and 7, and the shock resistance was poor in Comparative Example 7 as compared with Conventional Example 2. Therefore, the driving stability and high-speed durability in those Comparative Examples were not evaluated.

Driving stability: Each tire with an internal pressure of 250 kPa was mounted on a test vehicle of 2,000 cc displacement, the test vehicle was run on a test course by three trained test drivers, and the driving stability was evaluated by feeling. The scoring by test drivers was evaluated by relative comparison based on 6 points of the Conventional Example out of a maximum of 10 points. The driving stability was indicated by an index as the Conventional Example being 100. Driving stability is excellent as the index is large.

The results obtained are shown in Table 2.

TABLE 2

| | | Conven- | | | Compar- | Compar- | Compar- | Compar- |
|---|---|---|---|---|---|---|---|---|
| | | tional | | | ative | ative | ative | ative |
| | | Example 2 | Example 3 | Example 4 | Example 5 | Example 6 | Example 7 | Example 8 |
| Constitution | Material of cord | Ny66 | Ny66 | Ny66 | Ny66 | Ny66 | Ny66 | Ny66 |
| of belt | Constitution | 1400 dtex/2 | 1400 dtex/2 | 1400 dtex/2 | 1400 dtex/2 | 2100 dtex/2 | 1400 dtex/2 | 1400 dtex/2 |
| reinforcing | Nominal fineness (dtex) | 2800 | 2800 | 2800 | 2800 | 4200 | 2800 | 2800 |
| layer | Number of twist per 10 cm length | 37.8/38.6 | 26.2/27.6 | 26.2/27.6 | 37.8/38.6 | 31.3/30.5 | 37.8/38.6 | 37.8/38.6 |
| | (second/first) | | | | | | | |
| | Cord diameter (mm) | 0.68 | 0.67 | 0.67 | 0.68 | 0.84 | 0.68 | 0.68 |
| | Cord count (number/25 mm) | 30.0 | 30.0 | 28.0 | 34.0 | 25.0 | 26.0 | 32.0 |
| | Tensile toughness (J) | 4.3 | 5.4 | 5.4 | 4.3 | 6.9 | 4.3 | 4.3 |
| | Tensile toughness (J) × cord count | 129 | 162 | 151 | 146 | 173 | 112 | 138 |
| | (number/25 mm) | | | | | | | |
| | Load (N) at 2% extension | 14 | 17 | 17 | 14 | 14 | 18 | 14 |
| | Load (N) at 2% extension × Cord | 420 | 510 | 476 | 476 | 350 | 468 | 448 |
| | count (number/25 mm) | | | | | | | |
| | Thickness of belt reinforcing ply | 1.0 | 10 | 1.0 | 1.0 | 1.1 | 1.0 | 1.0 |
| | (mm) | | | | | | | |
| | Cord occupancy | 82 | 80 | 75 | 92 | 84 | 71 | 87 |
| Evaluation | Mass of belt reinforcing layer | 100 | 99 | 100 | 99 | 105 | 101 | 98 |
| | Shock resistance | 100 | 110 | 107 | 105 | 114 | 95 | 103 |
| | Driving stability | 100 | 111 | 106 | 106 | — | — | 100 |
| | High speed durability | 100 | 102 | 103 | 95 | — | — | 98 |

The following are seen from the results shown in the above Table.

In Examples 3 and 4, shock resistance, driving stability and high-speed durability were excellent while maintaining lightness of the belt reinforcing ply, as compared with Conventional Example 2.

Comparative Example 5 is the example in which the tensile toughness (J) per one organic fiber cord is outside the predetermined range, and high-speed durability was poor as compared with Conventional Example 2.

Comparative Example 6 is the example in which the nominal fineness of the organic fiber cord and the product of the load (N) at 2% extension per one organic fiber cord and the cord count (number/25 mm) are outside the predetermined ranges, and the mass of the belt reinforcing ply increased as compared with Conventional Example 2.

Comparative Example 7 is the example in which the tensile toughness (J) per one organic fiber cord and the product of the tensile toughness (J) per one organic fiber cord and the cord count (number/25 mm) are outside the predetermined ranges, and the mass of the belt reinforcing ply increased and shock resistance bras poor as compared with Conventional Example 2.

Comparative Example 8 is the example in which the tensile toughness (J) per one organic fiber cord and the product of the load (N) at 2% extension per one organic fiber cord and the cord count (number/25 mm) are outside the predetermined ranges, and high-speed durability was poor as compared with Conventional Example 2.

The pneumatic tire of the present invention can be used in various vehicles such as passenger cars, light trucks and buses.

The reference numerals and signs in the drawings are as follows.

T Tire

1 Bead part

2 Sidewall part

3 Tread part

4 Carcass

5 Bead core

6 Belt

6A First belt ply

6B Second belt ply

7 Tread rubber part

8 Belt reinforcing layer.

1. A pneumatic tire comprising a carcass, a belt arranged on the outer periphery of a crown part of the carcass and a belt reinforcing layer arranged on the outer periphery of the belt.
wherein the belt reinforcing layer is provided with a belt reinforcing ply which comprises an organic fiber cord having a double twisting structure obtained by intertwisting two first twisted yarns comprising a filament bundle of aliphatic polyamide fibers, having nominal fineness of 4000 dtex or less and having tensile toughness (J) per one cord of 5 J or more, and said belt reinforcing ply is arranged such that its major diameter direction is parallel to a belt outer periphery,
and the product of the toughness (J) per one organic fiber cord and cord count (number/25 mm) is 130 to 180.

2. The pneumatic tire according to claim 1, wherein the belt reinforcing layer has the product of a load (N) at 2% extension per one organic fiber cord and the cord count (number/25 mm) of 470 or more.

3. The pneumatic tire according to claim 1, wherein the aliphatic polyamide fiber comprises nylon 66.

4. The pneumatic tire according to claim 2, wherein the aliphatic polyamide fiber comprises nylon 66.

5. The pneumatic tire according to claim 1, wherein the belt reinforcing layer has the cord occupancy per unit width in the belt reinforcing ply of 85% or less.

6. The pneumatic tire according to claim 2, wherein the belt reinforcing layer has the cord occupancy per unit width in the belt reinforcing ply of 85% or less.

7. The pneumatic tire according to claim 3, wherein the belt reinforcing layer has the cord occupancy per unit width in the belt reinforcing ply of 85% or less.

8. The pneumatic tire according to claim 4, wherein the belt reinforcing layer has the card occupancy per unit width in the belt reinforcing ply of 85% or less.
